(19) United States
(12) Patent Application Publication
(10) Pub. No.: US 2019/0359059 A1
(43) Pub. Date: Nov. 28, 2019

(54) WORK VEHICLE HAVING DISPLAY UNIT FOR DISPLAYING FUEL CONSUMPTION AMOUNT

(71) Applicant: KUBOTA CORPORATION, Osaka (JP)

(72) Inventors: David SPITZ, Atlanta, GA (US); Chad PLAVCAN, Atlanta, GA (US); Justin MCCALLISTER, Cleveland, GA (US); Guy TORO, Lilburn, GA (US)

(73) Assignee: KUBOTA CORPORATION, Osaka (JP)

(21) Appl. No.: 15/986,279

(22) Filed: May 22, 2018

(51) Int. Cl. B60K 35/00; A01D 34/00; A01D 75/00

(52) U.S. Cl. CPC B60K 35/00; A01D 34/001; B60K 2350/921; B60K 2350/1092; A01D 75/00

(57) ABSTRACT

A work vehicle includes a main key having an ON position for enabling electric power supply to electric devices and an OFF position for stopping the electric power supply to the electric devices, an engine information acquiring section configured to acquire engine information including a fuel supply amount from an engine controlling section that calculates the fuel supply amount to the engine, a momentary fuel consumption amount calculating section configured to calculate a momentary fuel consumption amount based on the engine information, a total fuel consumption amount calculating section configured to calculate, based on the engine information, a total fuel consumption amount which is a total amount of fuel used from an ON state to an OFF state of the main key, and a display controlling section configured to selectively display the momentary fuel consumption amount and the total fuel consumption amount on a display unit.

### TECHNICAL FIELD

This invention relates to a work vehicle having a display unit for displaying a fuel consumption amount.

### BACKGROUND ART

Work vehicles disclosed in U.S. Pat. Nos. 8,991,143 and 9,572,298 include a mower unit as a utility implement and a flat display panel for displaying various kinds of data relating to a work run. A display screen of the display panel includes a fuel displaying area, a water temperature displaying area, an engine rotational speed displaying area, and an hour meter displaying area. A remaining fuel amount is displayed in the form of a bar graph showing a full tank state as 100% and an empty tank state as 0%.

U.S. Pat. No. 9,336,981 discloses a motor cycle having a meter comprised of a digital display unit. At one displaying area of this meter, an average fuel consumption amount and a momentary fuel consumption amount are displayed in an automatic switchover manner. This momentary fuel consumption amount is a running distance for 10 cc of fuel consumption amount. A method of calculating such momentary fuel consumption amount in a motor cycle which runs at a high speed is not suitable for fuel consumption efficiency evaluation of a work vehicle which runs at a low speed while driving its implement.

U.S. Pat. No. 9,575,628 discloses a display system for a work vehicle. This display system includes many screen pages, one of which includes a displaying area for displaying a remaining fuel amount, a vehicle speed, a fuel amount consumed per unit period. Incidentally, the document fails to disclose any method of calculating such fuel consumption amount per unit time.

In the case of a grass mower according to U.S. Patent Publication No. 2017/0196164, calculated fuel consumption amounts are recorded sequentially in a memory and with a button operation, a fuel consumption amount read out from the memory can be displayed.

In the case of a work vehicle, the vehicle does not necessarily run in a region providing a constant work load. Rather, the vehicle runs in a region providing high work load or a region providing low work load. As work load and fuel consumption have a fixed relationship, a running work state can be estimated from a momentary fuel consumption amount. Further, for the sake of work management, knowing a total fuel consumption amount of one day of work or work having one work value is also important.

### SUMMARY OF THE INVENTION

The object of the present invention is to provide a work vehicle such as a grass mower that can appropriately provide a driver with information relating to fuel consumption which is important in a work.

A work vehicle according to the present invention comprises:

an engine;

a main key having an ON position for enabling electric power supply to electric devices and an OFF position for stopping the electric power supply to the electric devices;

an engine controlling section configured to determine a fuel supply amount to the engine;

an engine information acquiring section configured to acquire engine information including the fuel supply amount from the engine controlling section;

a momentary fuel consumption amount calculating section configured to calculate a momentary fuel consumption amount based on the engine information;

a total fuel consumption amount calculating section configured to calculate, based on the engine information, a total fuel consumption amount which is a total amount of fuel used from an ON state to an OFF state of the main key; and

a display controlling section configured to selectively display the momentary fuel consumption amount and the total fuel consumption amount on a display unit.

With the above-described arrangement, when the main key of the work vehicle is turned ON to drive the engine, engine information including a fuel supply amount is outputted from the engine controlling section. Therefore, a momentary fuel consumption amount calculated based on this fuel supply amount can be displayed on the display unit. Further, when the main key is switched from ON to OFF, a total fuel consumption amount for the period from the ON state to the OFF state can be displayed on the display unit. With this, the driver can estimate a current fuel consumption amount, namely, a work load, from the momentary fuel consumption amount displayed in the display unit during vehicle run. And, from the total fuel consumption amount which is displayed at the time of completion of work, the driver can grasp a fuel consumption amount (work cost) consumed by the work done so far.

The momentary fuel consumption amount is displayed during a vehicle run, whereas the total fuel consumption amount is displayed substantially during a vehicle stop. For this reason, it will be efficient and advantageous if the momentary fuel consumption amount and the total fuel consumption amount are displayed in a common displaying area. In particular, the above arrangement will be particularly advantageous in case a flat display panel whose space available for displaying various kinds of information is rather limited is employed as the display unit.

According to one preferred embodiment of the present invention, displaying of the momentary fuel consumption amount is started by being triggered by turning ON of the main switch; whereas displaying of the total fuel consumption amount is started by being triggered by switchover of the main switch from the ON state to the OFF state and is stopped upon lapse of a predetermined period. With this arrangement, the momentary fuel consumption amount and the total fuel consumption amount are displayed automatically, so a button or the like for displaying becomes unnecessary. Thus, not only a button operation, but also a cost for arranging such button can be made unnecessary.

For estimation of work period until fuel exhaustion, it will be advantageous if a remaining fuel amount displaying area for displaying a remaining fuel amount in a fuel tank is disposed adjacent a displaying area for displaying the momentary fuel consumption amount.

### BRIEF DESCRIPTION OF THE DRAWINGS

FIG. 1 is a perspective view of a grass mower,

FIG. 2 is a perspective view of a display unit mounted on the grass mower,

FIG. 3 is a power line diagram of the grass mower,

FIG. 4 is a functional block diagram of a control system of the grass mower, and

FIG. 5 is a view of display screen showing one example of a screen of the display unit, displaying a momentary fuel consumption amount,

FIG. 6 is a view of display screen showing one example of a screen of the display unit, displaying a total fuel consumption amount, and

FIG. 7 is a timing chart showing displaying timings of the momentary fuel consumption amount, the total fuel consumption amount and an engine rotational speed.

### EMBODIMENTS

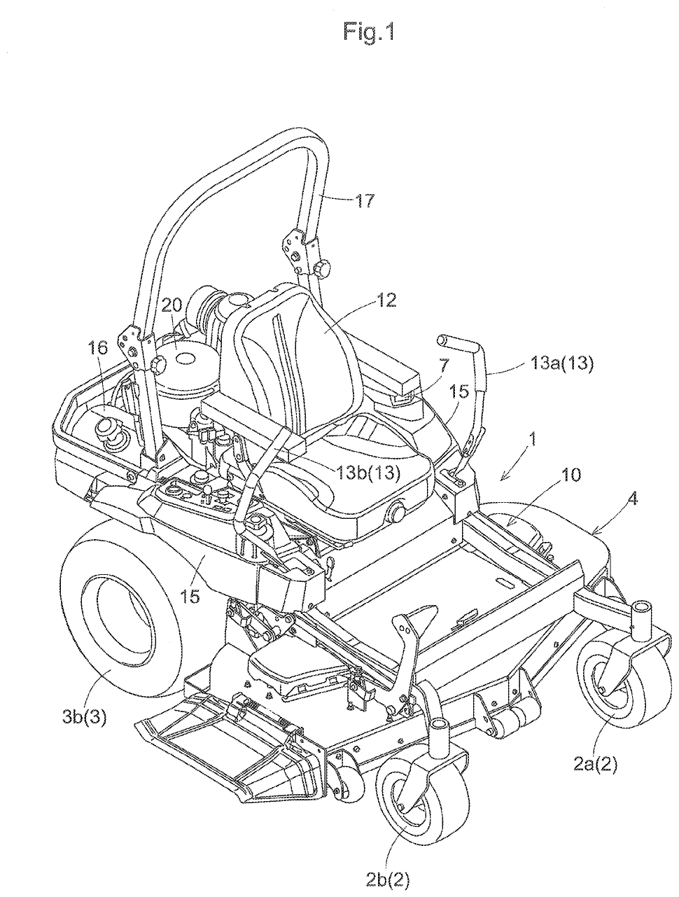

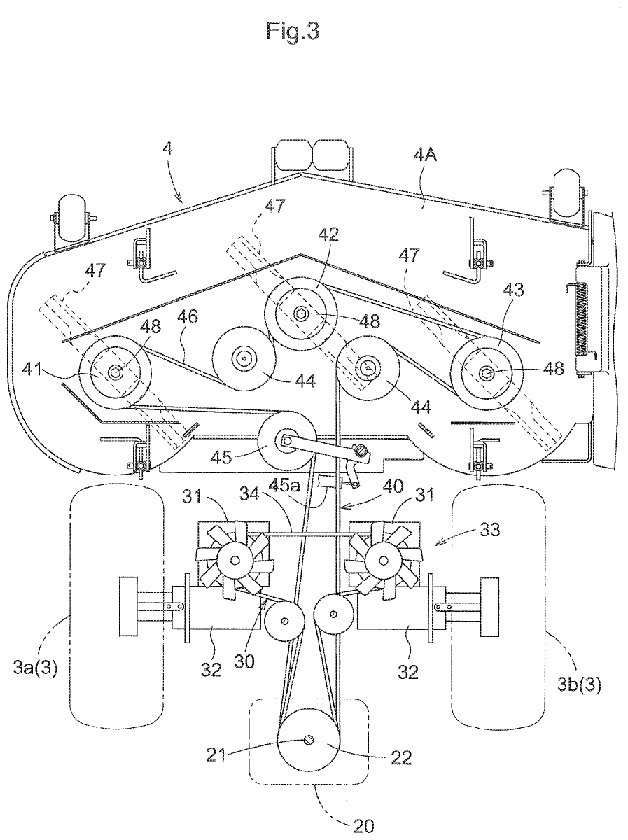

Next, a grass mower as one embodiment of a work vehicle according to the present invention will be explained with reference to the accompanying drawings. FIG. 1 is a perspective view of the grass mower. FIG. 3 is a power line diagram of the grass mower. In this detailed description, unless indicated otherwise, a word “front” means a front side with respect to a vehicle body front-rear direction (running direction), and a word “rear” means a rear side with respect to the vehicle body front-rear direction (running direction). Further, a left-right direction or a lateral direction means a vehicle body transverse direction (vehicle body width direction) perpendicular to the vehicle body front-rear direction. Also, a word “upper” or “lower” signifies a positional relationship in the perpendicular direction of the vehicle body (vertical direction), thus indicating a relationship respecting the ground height.

The grass mower includes a vehicle body 1 supported on a ground surface by means of a front wheel unit 2 as a caster unit and a rear wheel unit 3 as a running device. This grass mower is a so-called zero-turn mower configured such that a left rear wheel 3a and a right rear wheel 3b together constituting the rear wheel unit 3 are independently controllable in their speeds forwardly and reversely. The front wheel unit 2 includes a left front wheel 2a and a right front wheel 2b. The principal constituent component of the vehicle body 1 is a frame 10 consisting of angular pipe members, or the like. Between the front wheel unit 2 and the rear wheel unit 3, a mower unit 4 as a utility implement is suspended from the frame 10 to be liftable up/down.

The frame 10 extends in a front-rear direction, and at a center portion of the frame 10, a driver's seat 12 is provided. On an upper face of a front portion of the frame 10, a floor plate is mounted, to be used as a footrest for the driver.

An engine 20 for providing rotational power to the rear wheel unit 3 and the mower unit 4 is mounted at a rear portion of the frame 10. This engine 20 consumes fossil fuel such as heavy oil, gasoline, etc. The engine 20 is mounted under a posture with its engine output shaft 21 (see FIG. 3) protruding downwards. Laterally of the engine 20, a fuel tank 16 is mounted.

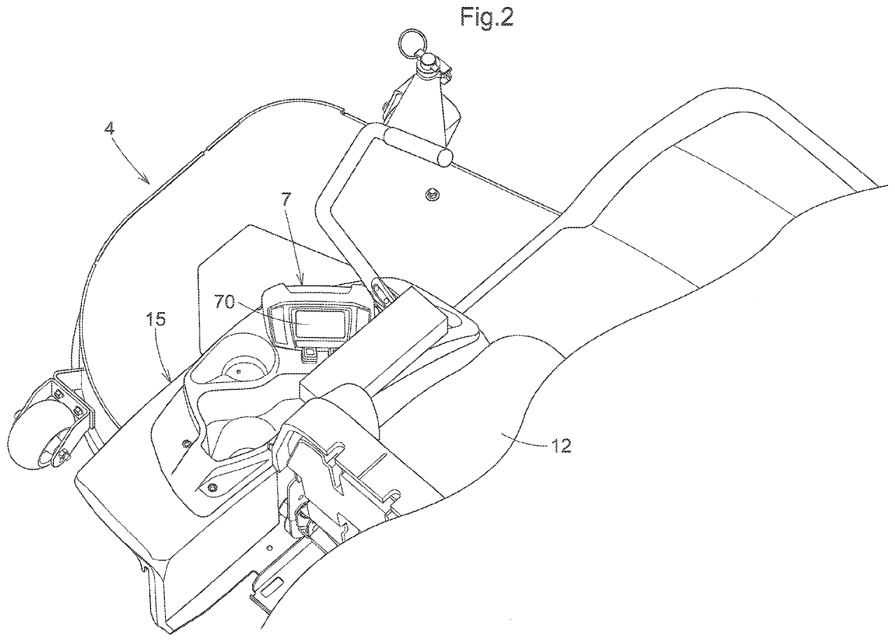

Rearwardly of the driver's seat 12, an arch-shaped ROPS 17 is mounted vertically. On the left and right sides of the driver's seat 12, fenders 15 are provided. On the upper faces of the fenders 15, user operational (control) devices such as various kinds of operational (control) levers, operational (control) buttons, etc. are provided. As shown in FIG. 2, on the upper face of the left fender 15, a display unit 7 constituting of liquid crystal or the like is mounted, with its screen 70 facing the face of a driver seated at the driver's seat 12.

A maneuvering unit 13 as one of the user operational devices consists of a left maneuvering lever 13a disposed on the left side of the driver's seat 12 and a right maneuvering lever 13b disposed on the right side of the driver's seat 12. The left maneuvering lever 13a is used for adjusting a rotational speed of the left rear wheel 3a and the right maneuvering lever 13b is used for adjusting the right rear wheel 3b. The left maneuvering lever 13a and the right maneuvering lever 13b can be pivotally displaced to/through/from a forward speed changing region, a neutral, and a reverse speed changing region.

As shown schematically in FIG. 3, the power transmission line includes a running transmission mechanism 30 for transmitting engine power to the rear wheel unit 2 and a PTO mechanism 40 for transmitting engine power to the mower unit 4. Power from the engine 20 is outputted from upper and lower two-stages of output pulleys 22 mounted on the engine output shaft 21.

The running transmission mechanism 30 includes a pair of left and right HST (hydrostatic transmissions) 31, a pair of left and right gear transmission mechanisms 32 and a running belt transmission mechanism 33. The running belt transmission mechanism 33 transmits power outputted from the output pulleys 22 to the HST's 31 via a running belt 34. The gear transmission mechanism 32 transmits power speed-changed by the HST's 31 to the rear wheel unit 3 (left rear wheel 3a, the right rear wheel 3b).

Speed changes by the left and right HST's 31 are effected via control signals generated in response to pivotal operations of the left maneuvering lever 13a and the right maneuvering lever 13b. In response to user operations on the left maneuvering lever 13a and the right maneuvering lever 13b, there are realized, a stopped state, forward running state, a gentle turn state, a pivot turn state and a spin turn state, respectively. The stopped state is realized by stopping the left rear wheel 3a and the right rear wheel 3b. The gentle turn state is realized by driving the left rear wheel 3a and the right rear wheel 3b at different speeds forwardly or reversely. The pivot turn state is realized by stopping one of the left rear wheel 3a and the right rear wheel 3b and driving the other forwardly or reversely. The spin turn state is realized by driving one of the left rear wheel 3a and the right rear wheel 3b forwardly and driving the other reversely.

The mower unit 4 includes a mower deck 4A comprised of a top plate and a side plate. In the inside space of the mower deck 4A, there are mounted three blades 47 juxtaposed in the vehicle body transverse direction as indicated by dotted lines in FIG. 3. Each blade 47 is fixed to a drive shaft 48 supported to the top plate of the mower deck 4A. In order to transmit power from the output pulley 22 of the engine 20 to the respective drive shafts 48, the PTO mechanism 40 is provided. The PTO mechanism 40 includes input pulleys 41, 42, 43 fixed to the drive shafts 48 of the respective blades 47, a turn pulley 44, a tension clutch pulley 45 as an implement clutch, and an implement belt 46 wound around these pulleys. With this arrangement, each blade 47 is rotated at a rotational speed in proportion to an engine rotational speed. The tension clutch pulley 45 is switched into an engaged state or a disengaged state, by a clutch solenoid 45a.

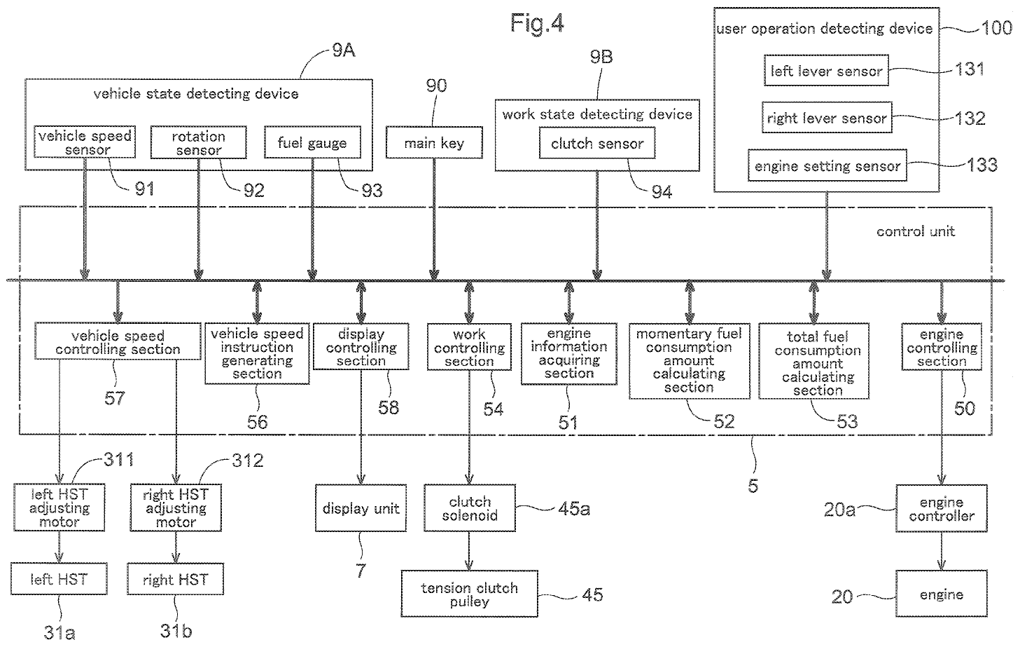

A control line of this grass mower is shown in FIG. 4. FIG. 4 is a functional block diagram of the control system of this grass mower. Incidentally, the respective functional blocks shown in FIG. 4 are provided for the purpose of explanation. Thus, integration, division and addition thereof can be made as desired. The core component of this control line is a control unit 5 which comprises substantially a computer system. To the control unit 5, there are connected a main key 90, a vehicle state detecting device 9A, a work state detecting device 90B, a user operation detecting device 100, etc. This main key 90 is an ignition switch which allows feeding of electric power to the respective electric components at its ON position and which stops the engine 20 at its OFF position.

The vehicle state detecting device 9A collectively represents sensors, switches etc. for detecting states relating to the vehicle and includes a vehicle speed sensor 91 for detecting a vehicle speed which is a running speed of the vehicle body 1, an engine rotational speed sensor 92 for detecting a rotational speed of the engine 20, and a fuel gauge for determining a remaining fuel amount in the fuel tank 16. The work state detecting device 9B collectively represents sensors, switches etc. for detecting work states of the mower unit 4 and includes a clutch sensor 94 for detecting an engaged or disengaged state of a tension clutch pulley 45 as a PTO clutch. The user operation detecting device 100 collectively represents sensors, switches etc. for detecting operations by a user and includes a left lever sensor 131 for detecting a pivotal displacement of the left maneuvering lever 13a, a right lever sensor 132 for detecting a pivotal displacement of the right maneuvering lever 13b, and an engine setting sensor 133 for detecting a set value of an engine rotational speed setter (not shown) such as an accelerator lever.

Further, to the control unit 5, there are connected the display unit 7, an engine controller 20a, the clutch solenoid 45a, a left HST adjusting motor 311, a right HST adjusting motor 312, and so on. The engine controller 20a adjusts a rotational speed of the engine 20 based on a control signal from the control unit 5. The clutch solenoid 45a effects an engaging/disengaging operation of the tension clutch pulley 45 based on a control signal from the control unit 5. The left HST adjusting motor 311 and the right HST adjusting motor 212 respectively adjust a swash plate angle of the left HST 31a and the right HST 31b, based on a control signal from the control unit 5, thus changing a vehicle speed.

The control unit 5 includes an engine information acquiring section 51, a momentary fuel consumption amount calculating section 52, a total fuel consumption calculating section 53, a work controlling section 54, an engine controlling section 55, a vehicle speed instruction generating section 56, a vehicle speed controlling section 57, and a display controlling section 58.

The work controlling section 54 provides the clutch solenoid 45a with control signals for effecting engaging and disengaging operations of the tension clutch pulley 45.

The vehicle speed instruction generating section 56 and the vehicle speed controlling section 57 are provided in case operations using the maneuvering unit 13 are provided in the by-wire method. Whereas, in an embodiment wherein such by-wire method is not employed and the maneuvering unit 13 and the pair of left and right HST's 31 are connected via physical linkage instead, the vehicle speed instruction generating section 56, the vehicle speed controlling section 57, the left HST adjusting motor 311 and the right HST adjusting motor 312 can be omitted. In the case of the by-wire method, the vehicle speed instruction generating section 56 generates vehicle speed instructions based on detection signals from the left lever sensor 131 and the right lever sensor 132 and then provides them to the vehicle speed controlling section 57. Then, based on the vehicle speed instructions (left vehicle speed instruction, right vehicle speed instruction), the vehicle speed controlling section 57 generates control signals for controlling the rear wheel unit 3. More particularly, a control signal based on a left vehicle speed instruction is provided to the left HST adjusting motor 311. With this, the swash plate angle of the left HST 31a is adjusted so that the left rear wheel 3a provides the vehicle speed based on the user operation. Similarly, a control signal based on a right vehicle speed instruction is provided to the right HST adjusting motor 312. With this, the swash plate angle of the right HST 31b is adjusted so that the right rear wheel 3b provides the vehicle speed based on the user operation.

The engine controlling section 55 generates a control signal, e.g. a fuel injection amount (a fuel supply amount), for controlling a rotational speed of the engine 20 based on a detection signal from the engine setting sensor 133 and provides it to the engine controller 20a. The engine controlling section 55 provides the engine information acquiring section 51 with engine information including a fuel supply amount.

The momentary fuel consumption amount calculating section 52 calculates a momentary fuel consumption amount based on the engine information obtained from the engine information acquiring section 51. This momentary fuel consumption amount is calculated while the main key 90 stays at the ON position (including the ignition position), namely, while the engine 20 is being driven. This momentary fuel consumption amount is calculated as a fuel consumption amount per unit period (suitably, from a few seconds to a few minutes), based on a fuel supply amount to the engine 20. The calculated momentary fuel consumption amount is sent to the display controlling section 58.

The total fuel consumption amount calculating section 53 calculates a total fuel consumption amount based also on the engine information obtained from the engine information acquiring section 51. The total fuel consumption amount is a total amount of fuel used from an ON state to an OFF state of the main key 90, namely while the engine is being driven. This can be obtained by integrating momentary fuel consumption amounts. A calculated total fuel consumption amount is sent to the display controlling section 58.

The display controlling section 58 generates display data for displaying the detection data of the vehicle state detecting device 9A, the work state detecting device 9B, the user operation detecting device 100, etc. and the data generated by the control unit 5 in predetermined regions of the display unit 7.

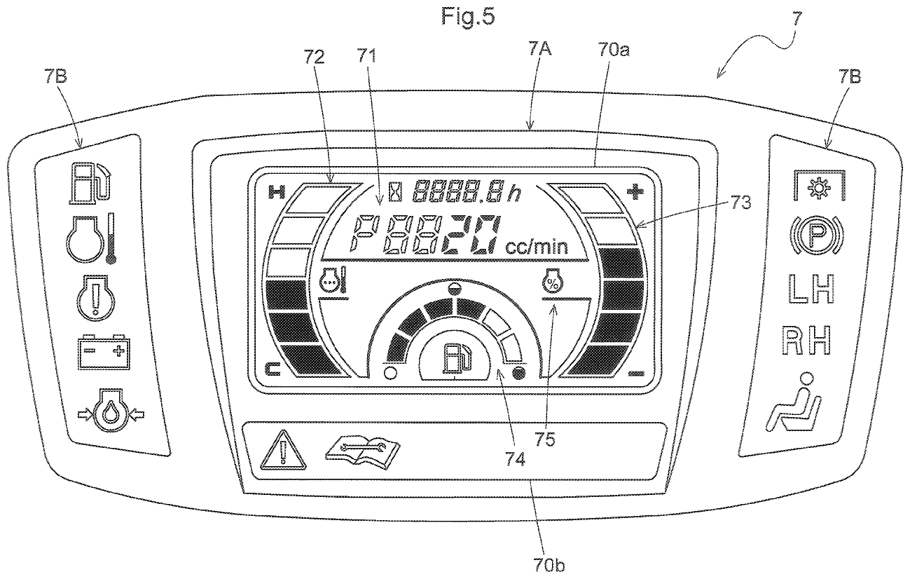

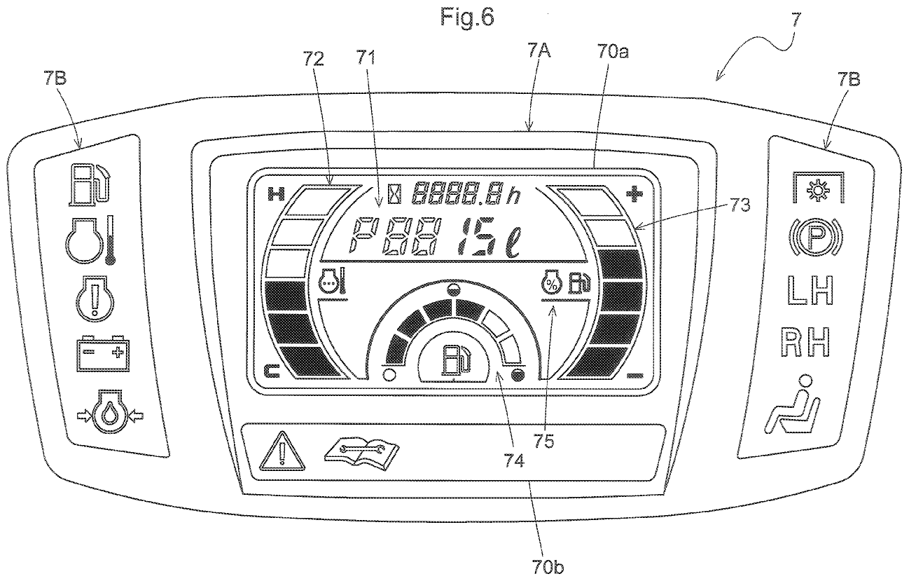

In this embodiment, the display unit 7, as shown in FIG. 5 and FIG. 6, consists of a liquid crystal displaying section 7A and LED lamp displaying sections 7B located on the opposed sides the liquid crystal displaying section 7A. The liquid crystal displaying section 7A is divided into a first area 70a and a second area 70b located on the lower side of the first area 70a. Further, the first area 70a is divided into a first segment 71, a second segment 72, a third segment 73 and a fourth segment 74 for graph-displaying or numerical displaying of variable data whose data values change sequentially. The first segment 71 employs upper and lower two rows of seven-segment numbers. In this embodiment, the upper-row segment number in the first segment 71 displays a total operation period, whereas the lower-row segment number selectively displays one of the momentary fuel consumption amount, the total fuel consumption amount and the engine rotational speed. In this, as an identifier 75 for identifying a selected data kind, a unit symbol or an icon will be displayed simultaneously. Incidentally, in FIG. 5, a momentary fuel consumption amount is displayed In FIG. 6, a total fuel consumption amount is displayed.

The left-side arcuate second segment 72 displays a water temperature of engine cooling water. The right-side arcuate third segment 73 displays an engine load ratio. The lower-side semi-circular fourth segment 74 displays a remaining fuel amount in the fuel tank 16. The second area 70b is a band-like liquid crystal area for displaying mainly a message, an alarm for the driver.

The LED lamp displaying sections 7B are configured such that by illuminating an icon provided on its surface with an LED lamp, the icon is highlighted for reporting an item content meant by the ion to the driver. As such icons, in the right LED lamp displaying section 7B, there are disposed e.g. an ion indicating a driver's seated state at the driver's seat 12 or an operational state of a parking brake, a neutral icon (a mark: LH) indicating neutral of the left maneuvering lever 13a, a neutral icon (a mark: RH) indicating neutral of the right maneuvering lever 13b, etc. In the left LED lamp displaying section 7B, as this is provided for the purpose of alarming, a red LED will be illuminated. In the right LED lamp displaying section 7B, as this is provided for the purpose of safety confirmation, a green LED will be illuminated.

For instance, if the left neutral icon 76 and the right neutral icon 77 are displayed, this means that left maneuvering lever 13a and the right maneuvering lever 13b are under the neutral state. So, under this state, an operation of the main key 90 to start the engine 20 will not result in inadvertent movement of the vehicle body 1. Whereas, if either one of the left maneuvering lever 13a and the right maneuvering lever 13b is not under the neutral state, there is the possibility of inadvertent movement of the vehicle body 1. So, there is provided a forcible safety control measure for not starting the engine 20. If the main key 90 is operated to attempt starting of the engine 20, but the engine 20 is not started, by checking at least one of the left neutral icon and the right neutral icon is not illuminated, the cause of this starting failure can be grasped.

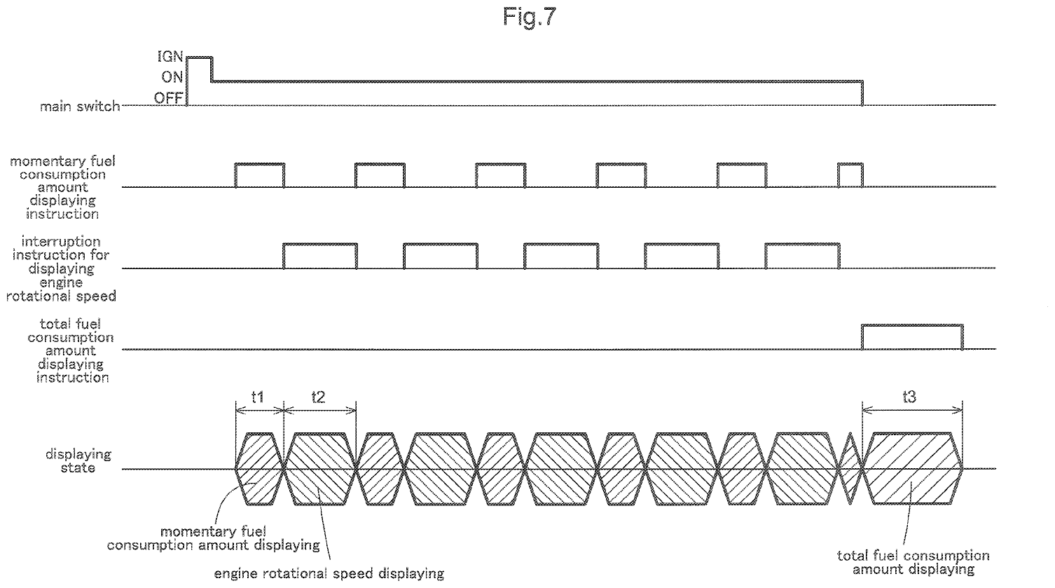

Next, with reference to FIG. 7, there will be explained displaying timings of a momentary fuel consumption amount, a total fuel consumption amount and an engine rotational speed which are displayed in the lower-row segment number in the first segment 71 of the display unit 7. Firstly, the main key 90 is operated to the ignition position to start the engine 20. Then, the main key 90 is returned to its ON position. As the mower unit 4 is driven and the left maneuvering lever 13a and the right maneuvering lever 13b are operated, a grass cutting work run is started. While the main switch 90 stays ON, by a predetermined cycle, the momentary fuel consumption amount calculating section 52 calculates a momentary fuel consumption amount and writes this into a memory. When a program of the control unit 5 provides a momentary fuel consumption amount displaying instruction, the display controlling section 58 reads out the momentary fuel consumption amount from the memory and displays this in the first segment 71. Upon lapse of a preset predetermined displaying period: t1 for momentary fuel consumption amount, the program of the control unit 5 provides an engine rotational speed displaying instruction to the display controlling section 58. In response to this, the display controlling section 58 displays an engine rotational speed calculated based on a detection signal from the rotation sensor 92 instead of the momentary fuel consumption amount in the first segment 71 for a predetermined displaying period: t2. Such alternating displaying of a momentary fuel consumption amount and an engine rotational speed will be continued until the main switch 90 is returned to its OFF position and the engine 20 is stopped.

When the main key 90 becomes OFF, the program of the control unit 5 provides a total fuel consumption amount displaying instruction to the display controlling section 58. With this, the display controlling section 58 will display a total fuel consumption amount for the period from ON to Off of the main key 90. This total fuel consumption amount can be obtained by integrating momentary fuel consumption amounts calculated from the ON state to the OFF state of the main key 90. Displaying of such total fuel consumption amount will be maintained for a preset period: t3 (about 30 seconds).

In the foregoing embodiment, a grass mower was described as an example of a work vehicle. However, the present invention is applicable to various kinds of work vehicle such as snow plow vehicle, a liquid agent sprinkling vehicle, etc.

1. A work vehicle comprising:
an engine;
a main key having an ON position for enabling electric power supply to electric devices and an OFF position for stopping the electric power supply to the electric devices;
an engine controlling section configured to determine a fuel supply amount to the engine;
an engine information acquiring section configured to acquire engine information including the fuel supply amount from the engine controlling section;
a momentary fuel consumption amount calculating section configured to calculate a momentary fuel consumption amount based on the engine information;
a total fuel consumption amount calculating section configured to calculate, based on the engine information, a total fuel consumption amount which is a total amount of fuel used from an ON state to an OFF state of the main key; and
a display controlling section configured to selectively display the momentary fuel consumption amount and the total fuel consumption amount on a display unit.

2. The work vehicle of claim 1, wherein the display unit comprises a flat display panel and the momentary fuel consumption amount and the total fuel consumption amount are displayed in a common displaying area.

3. The work vehicle of claim 1, wherein displaying of the momentary fuel consumption amount is effected as long as the main key stays ON and the engine is being driven, whereas displaying of the total fuel consumption amount is started by being triggered by switchover of the main switch from the ON state to the OFF state and is stopped upon lapse of a predetermined period.

4. The work vehicle of claim 3, wherein the total fuel consumption amount is calculated based on an integrated value of the momentary fuel consumption amounts from the ON to OFF state of the main key.

5. The work vehicle of claim 1, wherein the momentary fuel consumption amount and an engine rotational speed are displayed in alternation.

6. The work vehicle of claim 2, wherein in the flat display panel, adjacent the displaying area, there is disposed a remaining fuel amount displaying area for displaying a remaining fuel amount in a fuel tank.
